(19) United States
(12) Patent Application Publication
(10) Pub. No.: US 2004/0205068 A1
(43) Pub. Date: Oct. 14, 2004

(54) Unified platform for building and operating connected and disconnected mobile applications

(75) Inventors: Prakash Iyer, San Jose, CA (US); Amitabh B. Sinha, Redwood City, CA (US); Hideki Fujita, Kanagawa-ken (JP); Roopak Parikh, Santa Clara, CA (US)

Correspondence Address: PILLSBURY WINTHROP LLP, 2475 HANOVER STREET, PALO ALTO, CA, 94304-1114, US

(73) Assignee: EVERYPATH, INC.

(21) Appl. No.: 10/703,148

(22) Filed: Nov. 5, 2003

Related U.S. Application Data
(60) Provisional application No. 60/424,188, filed on Nov. 5, 2002.

(51) Int. Cl. G06F 7/00; G06F 17/30; G09G 5/00; G06F 15/16

(52) U.S. Cl. 707/10; 345/864; 709/203

(57) ABSTRACT

An integrated application platform for mobile devices unifies the server-sideand client-side wireless applications for connected, disconnected and mixed mode operation. The platform allows a user of a mobile device having a browser to access data from an enterprise system while the mobile device is in a connected mode of operation, a disconnected mode of operation or a mixed mode of operation. The enterprise system of one embodiment of the present invention includes a server, where the server interfaces with a database source adapter for adapting the data from a database on the enterprise system for use by the server. The mobile device and the unified server are provided with a multi-mode application and a smart client module. When the mobile device is in the connected mode, the multi-mode application and the smart client module operate from the server using data taken from the database on the enterprise system. When the mobile device is in the disconnected mode, the multi-mode application and the smart client module operate from the mobile device using a local copy of the data from the enterprise system database and stored locally on the mobile device. When the mobile device is in the mixed mode, the multi-mode application and the smart client module operate from both the server and the mobile device and use both the locally stored data and the enterprise system data.

### CROSS-REFERENCE TO RELATED APPLICATIONS

This application claims the benefit of priority under 35 U.S.C. § 119(e) from U.S. Provisional Patent Application No. 60/424,188 to Iyer, et al., which was filed on Nov. 05, 2002 and entitled “Unified Platform for Building Connected and Disconnected Mobile Applications,” and which is fully incorporated by reference for all purposes.

### BACKGROUND OF THE INVENTION

1. Field of the Invention

The present invention relates to software for network systems. More particularly, the present invention is directed to software and hardware for governing the connectivity between mobile devices and enterprise components of a network system and information infrastructure.

2. Description of the Related Art

In the growing world of wireless networking, a mobile worker needs applications that are continually available to him or her, irrespective of the wireless network coverage and connectivity. To allow the mobile worker to effectively complete all their required tasks, the client applications must overcome the numerous technical challenges. Among these are how to handle the applications when the network is not reachable or inoperable. For instance, if the mobile worker attempts to connect to a wireless network, but cannot, how many times will the application attempt to connect, or attempt to send data, before moving to a disconnected mode of operation? And when the application is operating in a disconnected mode, what happens to the user's data during that disconnected period. Further, when the application becomes reconnected via a wireless network, what happens to the user's data that was updated during the disconnected period? Additionally, when a crucial transaction is sent over the wireless network, can the application guarantee that it will be processed? The client application should provide robust behavior during unreliable network conditions; yet at the same time, it must be lightweight, memory efficient and fast to be useful in mobile networking environments.

Connected applications allow real-time updates for critical business functionality. They also allow the development of thin clients, which have immense advantages for deployment and maintenance. They also permit reuse of a large fraction of business logic resident in the enterprise applications.

Generally, mobile client applications are limited by storage space available on the mobile device, network coverage, network connectivity and the static nature of user data. The mobile worker often needs real-time connected access to back-end enterprise applications. The following three scenarios in the life of a mobile worker illustrate some of the problems that are frequently encountered during mobile computing.

First, to illustrate the storage limitations of mobile device, consider Tom, who is a sales representative with a pharmaceutical company, “PharmaCo.” Tom carries a handheld device, such as a personal digital assistant (PDA), that contains a local application and uses local data storage to keep track of his contacts and sales accounts. Tom has a meeting with Dr. Smith to talk about PharmaCo's products. During that meeting, he hears from Dr. Smith that Dr. Stewart, who is not currently an active client of Tom's, is interested in information about some of PharmaCo's products. Tom would like to give Dr. Stewart this information. But since he was not supposed to meet Dr. Stewart that day, he does not have Dr. Stewart's information loaded onto his mobile device. By accessing P's enterprise back-end directly from the same application in a real-time wireless connected mode, Tom can access Dr. Stewart's information for downloading to Tom's mobile device.

Second, to illustrate the limitation associate with different users, consider a salesperson or a field service agent who needs to have only the information that is relevant to them. However, a district manager or the Vice President of Operations may need information about many sales people or many field service agents. The information may be too large and too dynamic to be useful in a disconnected mode—executives and managers are interested in the latest problems. In such a scenario, the same information may be accessed in the disconnected mode by the field personnel, but in a connected mode by the manager or executive.

Third, to illustrate the limitations associated with real-time enterprise access, consider Mark, who is a sales representative with a consumer goods company, “GoodsCo.” He carries a mobile device, such as a wireless-capable notebook computer, that contains a local application and uses local data storage to keep track of his contacts, active sales accounts and previous sales data. Mark is visiting a retail customer to review that customer's inventory and place orders for items that are running short. His customer wants to know when the newly-placed orders will be shipped. Mark can use past inventory data previously stored on his mobile device to provide a shipment estimate. However, if Tom has wireless coverage and connectivity, he can access GoodsCo's enterprise system and provide his customer with a real-time, accurate shipping schedule.

The above scenarios can be summarized into basic types of problematic situations: one where the entire application is either in connected or disconnected mode; and one where some pieces of the application are in connected mode, while other pieces are in disconnected mode.

FIG. 1 illustrates the current method for building connected and disconnected applications in the mobile workplace, which typically requires multiple infrastructures. In this scenario 100, as shown, the developer must build two applications: a server-side application 110 and a client-side application 120. The server-side application supports “connected” access using JSPs (Java Server Pages), ASPs (Active Server Pages) and the like. The server-side application is typically built on an application server platform. The client-side application supports “disconnected” access using J2ME. (Java 2 Micro Edition), BREW (Binary Runtime Environment for Wireless), .Net (the Microsoft™ operating system development platform) and the like. The client-side application also typically includes a synchronization engine, which is needed to synchronize the client data with the server data.

Therefore, what is needed is an integrated application development and operation platform that unifies the server-side (i.e., infrastructure) and client-side.(i.e., mobile device) wireless application paradigms for connected, disconnected and mixed connected-disconnected operating modes.

### SUMMARY OF THE INVENTION

The present invention provides methods and systems for allowing a user of a mobile device with a browser to access data from an enterprise system while the mobile device is in a connected mode of operation, a disconnected mode of operations or a mixed mode of operations. The enterprise system of one embodiment of the present invention includes a unified server, where the unified server interfaces with a database source adapter for adapting the data from a database for use by the unified server. The mobile device and the unified server are provided with a unified application and a smart client. When the mobile device is in the connected mode, the unified application and the smart client operate from the unified server using data taken from the database on the enterprise system. When the mobile device is in the disconnected mode, the unified application and the smart client operate from the mobile device using a snapshot, or mirror, of the data from the enterprise system database and stored locally on the mobile device. When the mobile device is in the mixed mode, the unified application and the smart client operate from both the unified server and the mobile device and use both the locally stored data and the enterprise system data.

The present invention also includes, as part of the unified server, a synchronization client. The synchronization client coordinates synchronization of the locally stored data that may have been altered by the unified application during the disconnected mode to the enterprise system data once the mobile device is switch from the disconnected mode to the connected or mixed mode. The unified application provides the seamless switching of the mobile device between the different operating modes, and the smart client handles the user authentication process when switching between the operating modes.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates the current method for building connected and disconnected applications in the mobile workplace;

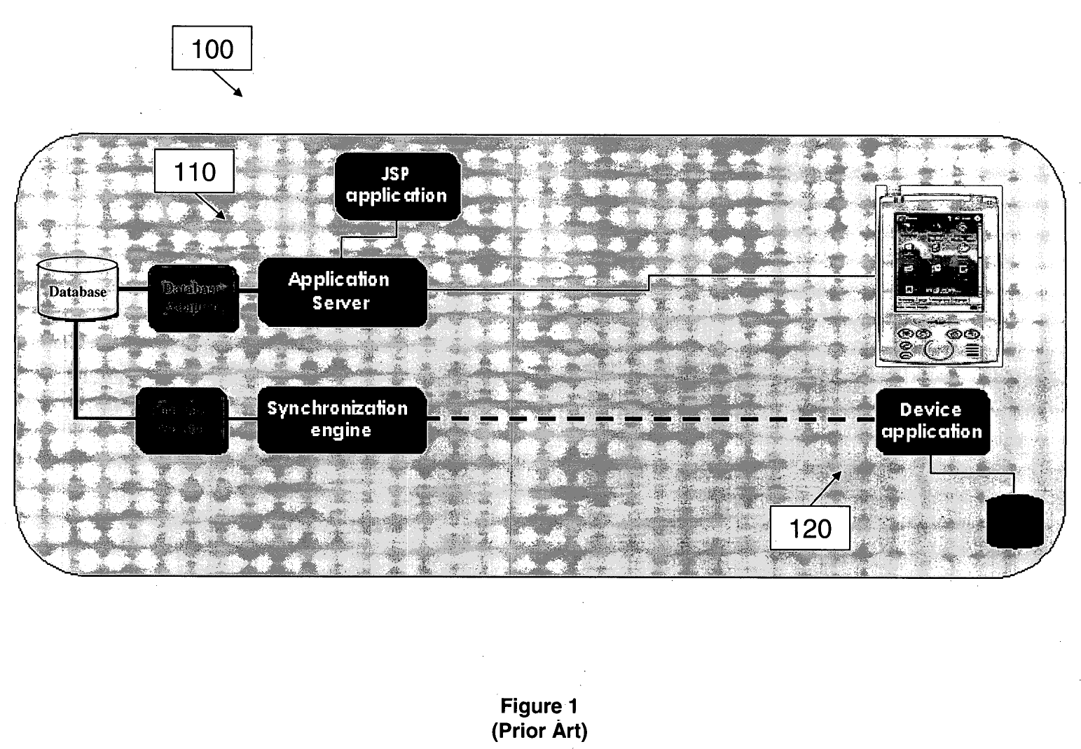

FIG. 2 illustrates a platform that unifies the infrastructure and application development paradigms for connected and disconnected applications according to an embodiment of the present invention;

FIG. 3 illustrates a connected operating mode embodiment according to the present invention;

FIG. 4 illustrates a disconnected operating mode embodiment according to the present invention; and

FIG. 5 illustrates a detailed architecture of the ESA unified server and mobile device configurations according to an embodiment of the present invention.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

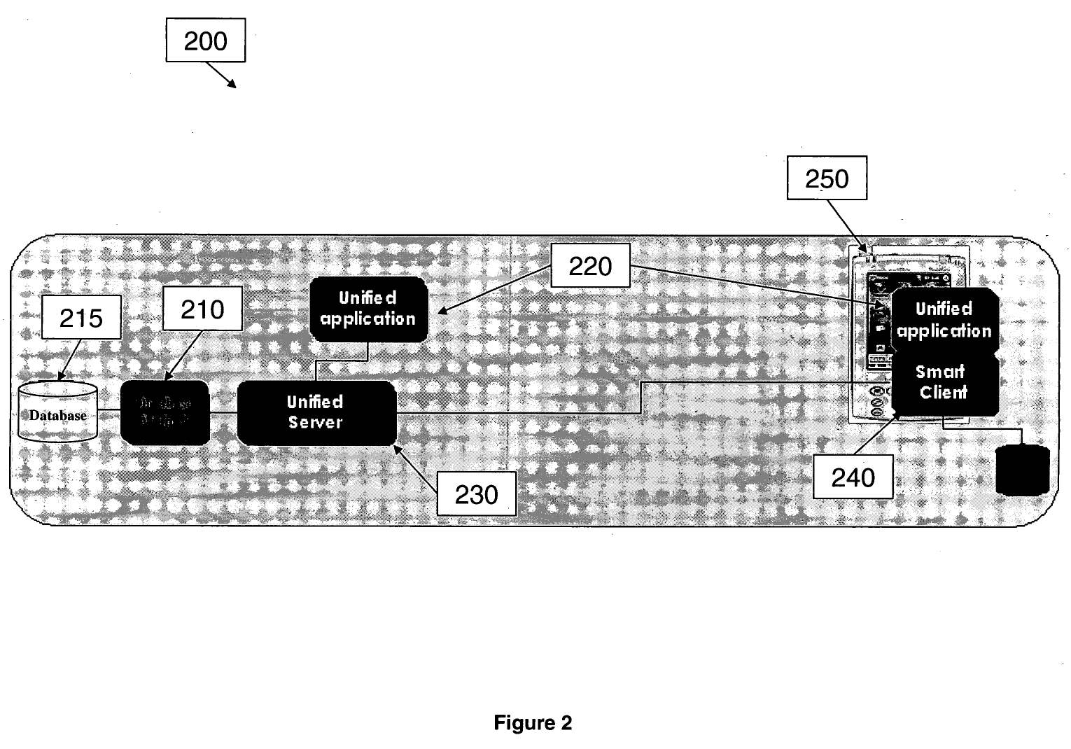

The present invention is directed towards a platform that unifies the infrastructure and application development paradigms for connected and disconnected applications. FIG. 2 illustrates an embodiment of the unifying platform 200 according to the present invention. As shown in FIG. 2, this embodiment includes a single adapter 210 per data source for connected and disconnected applications. In this example embodiment, a generic database data source is shown. However, any data source can be used (e.g., Siebel, SAP, Oracle, Access, etc.), with which a corresponding single adapter can be used. This embodiment further includes a single unified application 220 for both connected and disconnected functionality. Applications can be developed, for example, in xHTML (the Extensible Hypertext Markup Language) and can use the device browser for user interface. Further, the unified application can provide seamless switching between or within application operating modes, i.e., from connected to disconnected and from disconnected to connected, as well as within the connected/disconnected mixed-mode operation.

The platform 200 according to this embodiment also consists of the following components: a unified server, smart client software and a designer tool. The unified server 230 supports both connected and disconnected modes. It also provides real-time mobile access capabilities, in addition to synchronization server capabilities. The unified server 230 can, for example, be built on a standard J2EE (Java 2 Enterprise Edition) application server. The smart client software 240 on the mobile device 250 combines the functionality of a micro web server with a synchronization client. The micro web server functionality serves up the xHTML pages for rendering on the mobile device 250. The synchronization client functionality implements a robust and efficient engine for transactional data updates on the mobile device 250, as well as, a reliable handshake with the unified server 230 during real-time connected operation. The smart client can be implemented, for example, in Personal Java. A designer tool (not shown) provides a design studio environment to aid developers in building the unified applications.

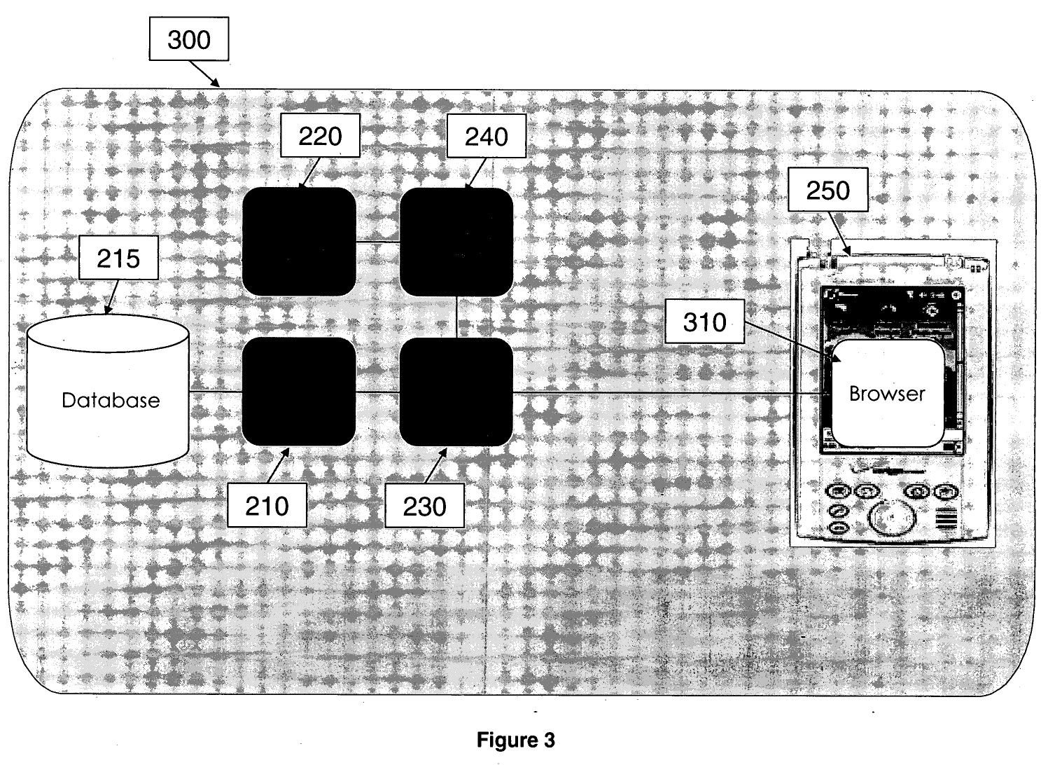

The smart client renders single applications for both connected and disconnected clients. FIG. 3 illustrates a connected operating mode embodiment 300 according to the present invention. As shown in FIG. 3, the smart client 240 renders the unified application 220 to a connected client, in this example a user with a wireless-capable mobile device 250. The unified application is deployed at the unified server 230. The user of the mobile device 250 connects to the unified server using the browser 310 on the device, for example, Internet Explorer or Netscape. The unified server 230 gets real-time data from the data source 215 using the unified adapter 210, e.g., Siebel or Oracle, and renders the data using the Smart Client 240.

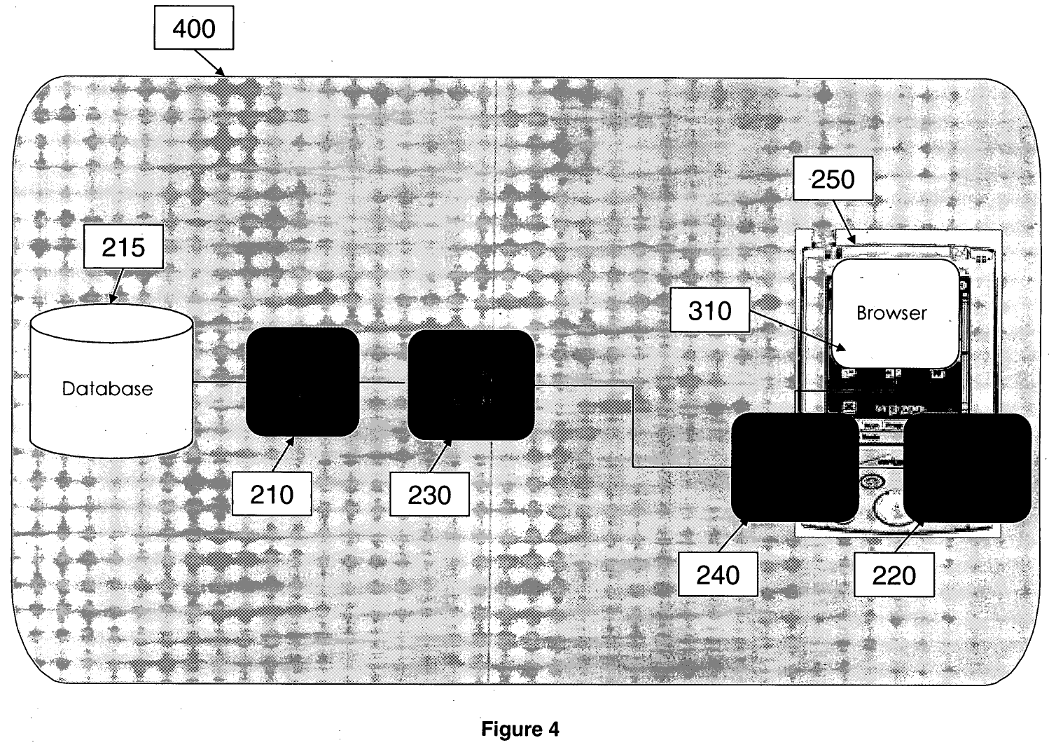

FIG. 4 illustrates a disconnected operating mode embodiment 400 according to the present invention. As shown in FIG. 4, the smart client 240 renders the unified application 220 in disconnected mode to the mobile device 250. The smart client 240 is deployed on the mobile device 250 along with the unified application. The user connects to the smart client using the browser 310 on the device 250, retrieves and copies a snapshot of the data from the data source 215 and stores it in SmartStore (discussed in more detail below) on the device 250, and uses SmartStore data with the unified application 220. While rendering any template in the unified application 220, the smart client uses the data persisted on the device 250. Similarly, all updates to SmartStore data take place on the local store of the device 250. When the user initiates connected mode and a synchronization operation, the smart client uploads the changes (e.g., additions, deletions, amendments, etc.) to the local store data from the device 250 to the data source 215 and gets a new snapshot of the data for future connected or disconnected unified application 220 operation.

A further embodiment of the present invention includes mixed-mode operation of the unified application. As used herein, mixed-mode operation pertains to the situation where some aspects of the unified application are operating in connected mode (as discussed in relation to FIG. 3), while, simultaneously, other aspects of the unified application are operating in disconnected mode (as discussed in relation to FIG. 4). In this mixed-mode, the unified application is deployed at the unified server as well as the device. Thus, the present invention supports the following operating scenarios: connect to the smart client on the unified server in connected mode; connect to the smart client on the mobile device in disconnected mode; and connect to the smart client of both the unified server and the mobile device to navigate freely between connected and disconnected modes.

The unified application 220 according to an embodiment of the present invention is a single, unified application that can support multiple data sources (e.g., Siebel, SAP, Oracle, etc.). The data from each of these data sources can be modeled through multiple objects on the mobile device. One example of the unified application can operate in one of three modes: disconnected mode (i.e., access local snapshot data storage); connected mode (access server-side ‘live’ data); and mixed-mode. In each of the modes, the objects in the unified application get their data in the same manner (discussed in more detail below). Thus, if the application (or a portion of it) is disconnected and is getting device-local data, then all the objects from that application (or application portion) provide data from local storage. The user of the device can choose the mode of the application right at the beginning, but can change the mode anytime during operation.

Henceforth, we will talk about an application being in one of two modes: connected (which will include mixed-mode) or disconnected. In connected mode, the data (or at least some of it) come from the server, and in disconnected mode all the data come from the local store snapshot on the mobile device.

In another embodiment of the present invention, there are at least two mechanisms used to control the operating mode. First, a URL (either embedded or user entered) in the unified application may directly connect to the unified server to force the device to be in connected mode. This may be used to operate portions (i.e., mixed-mode) of the unified application in connected mode, while the remaining portions of the unified application operate in disconnected mode. For example, in the business case of real-time access, the application developer may choose to embed server URLs in the unified application to provide connected access to only a portion of the unified application. In this example, real-time inventory shipment and delivery data, which would otherwise be unavailable to a disconnected device, can be connected for ready access.

The second mechanism used to control the operating mode is to use the switchMode action to switch the mode of the current operating access. In the business case, discussed above, of storage limitations and different users' requirements, the application developer would use the switchMode action to switch the operating mode of the unified application based on, for example, the limited storage available on the mobile device or the specific user's requirements.

Detailed Architecture

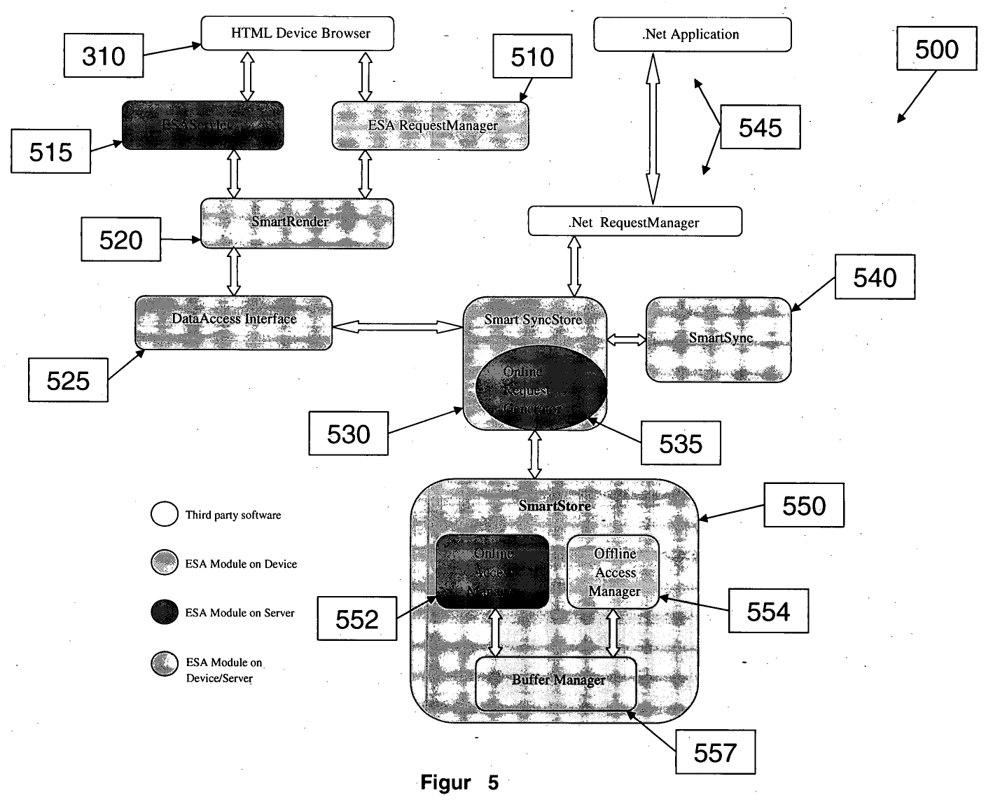

FIG. 5 illustrates a detailed architecture of the Everypath Smart Client/Agent (ESA) unified server and mobile device configurations according to the present invention. As shown in FIG. 5, ESA is a set of components that run as part of the enterprise to support connected modes of operation, as well as part of the mobile device to support disconnected modes of operation. The enterprise-specific components of ESA are the ESAServlet 515, the Online Request Generator 535 of SyncStore 530 and the Online Access Manager 552 of SmartStore 550. The device-specific components of ESA are the ESA RequestManager 510 and the Offline Access Manager 554 of SmartStore 550. Components of ESA that contain functionality for both the enterprise and the device are SmartRender 520, the DataAccess Interface 525, SyncStore 530, SmartSync 540 and SmartStore 550. Each of these components of this embodiment of the present invention is presented in detail below.

Request Management

In this embodiment, the ESA RequestManager 510 provides limited web container functionality to service requests from the browser 310 on the mobile device. The ESAServlet 515 is the front end (i.e., on the unified server at the enterprise) when ESA is running in a web container. It is the controlling servlet of a unified application to be executed on a server. ESA RequestManager 510 and the ESAServlet 515 can provide, for example, at least the following functionality: authentication and session management; forwarding requests to SmartRender 520; and transitioning between connected and disconnected modes of operation.

SmartRender

A unified application according to the present invention can have one or more rendering templates and one or more action templates. For example, an action template can be used to change the state of the data (e.g., model in an model view controller (MVC) paradigm) and a rendering template can be used to present a subset of data (e.g., corresponds to view in an MVC paradigm). The SmartRender 520 system provides the infrastructure to execute an action template or a rendering template in the context of a request and the associated session. A template can be written in, for example, xHTML (Extensible Hypertext Markup Language) and the rendering system executes these templates. However, any other suitable language could be used. The rendering language has constructs for data access, data manipulation, as well as data synchronization. The rendering system uses the Smart SyncStore API for data access and synchronization.

Data Access Interface

The data access layer provides a DataAccess Interface 525 to manipulate the data in the SmartStore. According to this example of the present invention, the DataAccess Interface 525 provides the following services to the SmartRender 520 system: executing a query; transactional support (e.g., commit, rollback, etc.); deleting a record; inserting a record and updating a record. However, this list of functions is not meant to be exhaustive. Those skilled in the art will easily recognize other functions that can be provided by the DataAccess Interface, which are intended to be within the scope of the present invention.

Smart SyncStore

The Smart SyncStore 530 module at least encapsulates SmartSync 540 and SmartStore 550. It provides an interface to write the unified applications onto the mobile device. This layer is a wrapper around SmartSync and SmartStore. In the connected (i.e., online) mode, the Online Request Generator 535 keeps track of the state of downloaded objects and generates appropriate download request to execute a statement.

SmartSync

The SmartSync 540 module enables bidirectional synchronization between SmartStore 550 and a mobile task automation, or MTA, server (also known as OSA). In the disconnected mode, the SmartSync 540 provides asynchronous uploads, synchronous downloads and delta downloads using HTTP protocol.

SmartStore

On the mobile device, the SmartStore 550 is used as a database management system (DBMS) to store a snapshot of the data taken via the unified server for each unified application on the device. In this configuration, each unified application has its own database and the rendering engine accesses each database, for example, using a JDBC (Java Database Connectivity) interface. Those skilled in the art will recognize that an ODBC interface (Open. Database Connectivity), or other similar interface, can be used with the present invention. The DBMS interface stores the data in native files and when a RequestManager commits a transaction, the changes are committed to the database. The SmartSync 540 system will propagate these changes to the data source at a later time of connectivity.

On the unified server, SmartStore 550 buffers the online, real-time, data and provides a structured query language (SQL) front end to access the buffered, real-time data. As will be evident to those skilled in the art, other query types can also be used with this aspect of the present invention. The execution model ensures that all the data required to execute a query is buffered in the SmartStore 550.

Mode Transition

Authentication in Disconnected Mode

When a user tries to connect to ESA on the mobile device, ESA requests for the user to enter credentials and then authenticates these credentials to create a unified application session. Typically, user credentials are stored in the user profile and a profile adapter ensures that the credentials on the device are consistent with the credentials on the server. However, other credential verification methods are known in the art and can be used with the present invention.

Authentication in Connected Mode

When ESAServlet receives the initial request for connected mode operation, it authenticates the user for online usage, and creates a session for the request if the user is successfully authenticated. ESAServlet will use, for example, a cookie-based mechanism to keep track of a session. A time out based session termination mechanism can also be implemented, where the ESAServlet ends connectivity following some predefined time period of user inactivity. When a session is terminated, regardless of how, all of the resources allocated to the session will be released.

Propagating Authentication Across Modes

When a user switches to connected mode from disconnected mode, ESA on the device submits the user credentials to the unified server. ESA on the unified server authenticates these credentials and creates an online (i.e., connected) session. If the user profile on the device is not consistent with that of the unified server, authentication may fail at the server, leaving the user to work in disconnected mode.

An application developer can use an action template with a special tag <epr:switchMode> to transition between online and offline access. This is accomplished by specifying an action template that contains <epr:switchMode> in a query string. An application developer could use a transition URL that has a transition action template in any place. When the user sends a transition request, the front end (i.e. server components) of the ESA switches the mode of operation. If the ESA RequestManager 510 receives an HTTP request to switch the mode, it redirects the request to the online URL specified from/for that unified application. The ESAServlet 515 running at the online server, if necessary, creates a session and renders the main page of the application. Since all of the URLs in the unified application are relative URLs, the device browser will automatically redirect the subsequent requests to the ESAServlet 515.

If the ESAServlet receives a request to switch modes, it redirects the request to the web container of the RrequestManager on the mobile device. Since the address of a web container is the same for all of the devices, the ESAServlet does not need any additional information.

When a mode is switched, ESA does not request credentials for authentication. The ESA running on the server and the ESA running on the device may exchange credentials during mode switching. ESA requests for credentials only when the connected and disconnected sessions have timed out.

Although the present invention has been described in detail with reference to the disclosed embodiments thereof, those skilled in the art will appreciate that various substitutions and modifications can be made to the examples described herein while remaining within the spirit and scope of the invention as defined in the appended claims. Also, the methodologies described may be implemented using any combination of software, specialized hardware, firmware or a combination thereof and built using ASICs, dedicated processors or other such electronic devices.

What is claimed is:

1. A method for providing a user of a mobile device having a browser access to data from an enterprise system containing a database and a database source adapter in at least one of a connected mode, a disconnected mode and a mixed mode, the method comprising the steps of:
providing the enterprise system with a server, wherein the server interfaces with the data on the database through the database source adapter, and the server is capable of a mobile connection with the mobile device;
loading both a multi-mode application and a smart client module onto both the server and the mobile device;
loading a local copy of the data from the database into a local memory of the mobile device;
executing, while the mobile device is in the connected mode using the mobile connection, both the multi-mode application and the smart client module from the server using the data from the database;
executing, while the mobile device is in the disconnected mode, both the multi-mode application and the smart client module from the mobile device using the local copy of the data from the local memory of the mobile device;
executing, while the mobile device is in the mixed mode using the mobile connection, a first part of both the multi-mode application and the smart client module from the server using the from the database, and a second part of both the multi-mode application and the smart client module from the mobile device using the local copy of the data from the local memory of the mobile device; and
wherein executing the smart client renders the executed multi-mode application onto the browser of the mobile device.

2. The method of claim 1, wherein the server further interfaces with additional data from additional databases through additional source adapters.

3. The method of claim 2, wherein the databases include one or more of a Siebel database, an Oracle database, an Access database, and an SAP database.

4. The method of claim 1, wherein the server is built using a J2EE application server.

5. The method of claim 1, wherein the server further includes a synchronization client module that synchronizes the local copy of the data from the local memory of the mobile device with the data from the database while the mobile device is in the connected mode.

6. The method of claim 1, wherein the server further includes a synchronization client module that synchronizes the local copy of the data from the local memory of the mobile device with the data from the database while the mobile device is in the mixed mode.

7. The method of claim 1, wherein the multi-mode application further operates to provide seamless switching between the connected mode, the disconnected mode and the mixed mode.

8. The method of claim 7, wherein the smart client module further operates to authenticate the user when the multi-mode application seamlessly switches to at least one of the connected mode and the mixed mode from the disconnected mode.

9. The method of claim 1, wherein the multi-mode application is built using sHTML.

10. The method of claim 1, wherein the smart client module includes one or more of:
a request manager module;
a smart render module;
a data access interface; and
a smart sync/store module, the smart sync/store module including a connected mode request generator.

11. The method of claim 10, wherein the smart sync/store module further includes one or more of:
a smart sync sub-module; and
a smart store sub-module, the smart store sub-module including at least one of a connected mode manager, a disconnected manager, and a data buffer manager.

12. A system for providing a user of a mobile device having a browser access to data from an enterprise system containing a database and a database source adapter in at least one of a connected mode, a disconnected mode and a mixed mode, the system comprising:
means for providing the enterprise system with a server, wherein the server interfaces with the data on the database through the database source adapter, and the server is capable of a mobile connection with the mobile device;
means for loading both a multi-mode application and a smart client module onto both the server and the mobile device;
means for loading a local copy of the data from the database into a local memory of the mobile device;
means for executing, while the mobile device is in the connected mode using the mobile connection, both the multi-mode application and the smart client module from the server using the data from the database;
means for executing, while the mobile device is in the disconnected mode, both the multi-mode application and the smart client module from the mobile device using the local copy of the data from the local memory of the mobile device;
means for executing, while the mobile device is in the mixed mode using the mobile connection, a first part of both the multi-mode application and the smart client module from the server using the from the database, and a second part of both the multi-mode application and the smart client module from the mobile device using the local copy of the data from the local memory of the mobile device; and
wherein executing the smart client renders the executed multi-mode application onto the browser of the mobile device.

13. The system of claim 12, wherein the server further includes a means for interfacing with additional data from additional databases through additional source adapters.

14. The system of claim 13, wherein the databases include one or more of a Siebel database, an Oracle database, an Access database, and an SAP database.

15. The system of claim 12, wherein the server is built using a J2EE application server.

16. The system of claim 12, wherein the server further includes a synchronization client module that synchronizes the local copy of the data from the local memory of the mobile device with the data from the database while the mobile device is in the connected mode.

17. The system of claim 12, wherein the server further includes a synchronization client module that synchronizes the local copy of the data from the local memory of the mobile device with the data from the database while the mobile device is in the mixed mode.

18. The system of claim 12, wherein the multi-mode application further includes a means for operating to provide seamless switching between the connected mode, the disconnected mode and the mixed mode.

19. The system of claim 18, wherein the smart client module further includes a means for operating to authenticate the user when the multi-mode application seamlessly switches to at least one of the connected mode and the mixed mode from the disconnected mode.

20. The system of claim 12, wherein the multi-mode application is built using sHTML.

21. The system of claim 12, wherein the smart client module includes one or more of:
a request manager module;
a smart render module;
a data access interface; and
a smart sync/store module, the smart sync/store module including a connected mode request generator.

22. The system of claim 21, wherein the smart sync/store module further includes one or more of:
a smart sync sub-module; and
a smart store sub-module, the smart store sub-module including at least one of a connected mode manager, a disconnected manager, and a data buffer manager.

23. A mobile device having a browser capable of accessing data from an enterprise system in at least one of a connected mode, a disconnected mode and a mixed mode, the enterprise system containing a database, a database source adapter and a server that interfaces with the data on the database through the database source adapter and that is capable of a mobile connection with the mobile device, the mobile device comprising:
means for loading both a multi-mode application and a smart client module onto both the server and the mobile device;
means for loading a local copy of the data from the database into a local memory of the mobile device;
means for executing, while the mobile device is in the connected mode using the mobile connection, both the multi-mode application and the smart client module from the server using the data from the database;
means for executing, while the mobile device is in the disconnected mode, both the multi-mode application and the smart client module from the mobile device using the local copy of the data from the local memory of the mobile device;
means for executing, while the mobile device is in the mixed mode using the mobile connection, a first part of both the multi-mode application and the smart client module from the server using the from the database, and a second part of both the multi-mode application and the smart client module from the mobile device using the local copy of the data from the local memory of the mobile device; and
wherein executing the smart client renders the executed multi-mode application onto the browser of the mobile device.
